(19) United States
(12) Patent Application Publication
(10) Pub. No.: US 2022/0236818 A1
(43) Pub. Date: Jul. 28, 2022

(54) ELECTRONIC APPARATUS

(71) Applicant: Samsung Display Co., Ltd., Yongin-Si (KR)

(72) Inventors: YERIN OH, Ulsan (KR); SOOWON KIM, Cheonan-si (KR); JASEUNG KU, Yongin-si (KR); SUHYUN JEONG, Asan-si (KR)

(21) Appl. No.: 17/539,607

(22) Filed: Dec. 1, 2021

(30) Foreign Application Priority Data
Jan. 25, 2021 (KR) 10-2021-0010441

(51) Int. Cl. G06F 3/046; G06F 3/0354

(52) U.S. Cl. CPC G06F 3/046; G06F 2203/04102; G06F 3/03545

(57) ABSTRACT

An electronic apparatus includes an electronic panel, which is foldable about a folding axis extending in a first direction and includes an active area on which an image is displayed, and a sensing module which is disposed below the electronic panel and senses an external input and includes first and second sensors spaced apart from each other. The active area includes a first area, a folding area, and a second area, which are arranged in a second direction crossing the first direction, and the folding axis overlaps the folding area in a plan view. The first sensor overlaps the first area, and the second sensor overlaps the second area and is spaced apart from the first sensor with the folding area therebetween in the plan view.

This application claims priority to Korean Patent Application No. 10-2021-0010441, filed on Jan. 25, 2021, and all the benefits accruing therefrom under 35 U.S.C. § 119, the content of which in its entirety is herein incorporated by reference.

### BACKGROUND

### 1. Field

Embodiments of the invention herein relate to an electronic apparatus which senses an input from an electromagnetic instrument.

### 2. Description of the Art

Electronic apparatuses may sense an external input applied from the outside. The external input may be an input of a user. The input of the user may include various types of external inputs such as a portion of the user's body, light, heat, an electromagnetic pen, or pressure. In particular, the electronic apparatuses may include digitizers for sensing a touch by an electromagnetic pen. The digitizers in various forms such as an electromagnetic resonance (“EMR”) type or an active electrostatic (“AES”) type may be utilized in the electronic apparatuses.

### SUMMARY

Embodiments of the invention provide an electronic apparatus foldable and capable of sensing a touch by an electromagnetic instrument.

An embodiment of the invention provides an electronic apparatus including an electronic panel which is foldable about a folding axis extending in a first direction and includes an active area on which an image is displayed, and a sensing module which is disposed below the electronic panel and senses an external input and includes first and second sensors spaced apart from each other, where the active area includes a first area, a folding area, and a second area, which are arranged in a second direction crossing the first direction, and the folding axis overlaps the folding area in a plan view, where the first sensor overlaps the first area, and the second sensor overlaps the second area and is spaced apart from the first sensor with the folding area therebetween in the plan view.

In an embodiment, at least one of the first sensor and the second sensor may include a plurality of coils for electromagnetic induction.

In an embodiment, the electronic panel may include a plurality of pixels which generates the image, and some pixels of the plurality of pixels may overlap the folding area.

In an embodiment, the electronic apparatus may further include an input sensor which is disposed on the plurality of pixels and senses an external input having a different form from the external input sensed by the sensing module.

In an embodiment, the input sensor may include a plurality of sensing patterns, and sensing patterns of the plurality of sensing patterns may overlap the folding area.

In an embodiment, the electronic apparatus may further include a support plate disposed below the sensing module, where the support plate includes metal.

In an embodiment, the support plate may overlap the folding area, the first area, and the second area.

In an embodiment, a plurality of holes, which overlap the folding area, may be defined in the support plate.

In an embodiment of the invention, an electronic apparatus includes an electronic panel which is foldable about a folding axis extending in a first direction and senses a first external input, and a sensing module which is disposed below the electronic panel and senses a second external input different from the first external input, where the electronic panel includes a folding area which is foldable about the folding axis and a first area and a second area which are spaced apart from each other with the folding area therebetween in a second direction crossing the first direction in a plan view, and the folding axis overlaps the folding area in the plan view, where the sensing module does not overlap the folding area in the plan view.

In an embodiment, the second external input may be an electromagnetic pen.

In an embodiment, the sensing module may include a first sensor overlapping the first area and a second sensor overlapping the second area, where the first sensor and the second sensor include side surfaces which face each other with the folding area therebetween.

In an embodiment, the electronic panel may further include a display panel including a plurality of pixels, and pixels of the plurality of pixels may overlap the folding area.

In an embodiment, the electronic apparatus may further include a support plate disposed below the sensing module, where the support plate overlaps the folding area.

In an embodiment, a plurality of openings, which overlap the folding area, may be defined in the support plate.

In an embodiment of the invention, an electronic apparatus includes an electronic panel which is foldable about a folding axis extending in a first direction and includes an active area on which an image is displayed, and a first sensor and a second sensor which are disposed below the electronic panel and spaced apart from each other, and each of which senses a first external input, where the active area includes a first area, a folding area, and a second area, which are arranged in a second direction crossing the first direction, and the folding axis overlaps the folding area in a plan view, where the first sensor and the second sensor include side surfaces which face each other with the folding area therebetween.

In an embodiment, the first external input may be not sensed in the folding area.

In an embodiment, the image may include a first image provided in the first area, a second image provided in the second area, and a third image provided in the folding area, where the first image and the second image are output corresponding to the first external input, and the third image does not correspond to the first external input.

In an embodiment, the electronic panel may further include a sensing sensor which senses a second external input different from the first external input, where the sensing sensor senses the second external input applied to the folding area.

In an embodiment, the third image may be output corresponding to the second external input.

In an embodiment, each of the first sensor and the second sensor may include a digitizer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain principles of the invention. In the drawings:

FIGS. 1A and 1B are perspective views of an embodiment of an electronic apparatus according to the invention;

FIGS. 2A and 2B are perspective views of an embodiment of an electronic apparatus according to the invention;

FIG. 2C is a plan view of an embodiment of an electronic apparatus according to the invention;

FIG. 3A is an exploded perspective view of an embodiment of an electronic apparatus according to the invention;

FIG. 3B is a block diagram of the electronic apparatus illustrated in FIG. 3A;

FIGS. 4A and 4B are cross-sectional views of an embodiment of an electronic apparatus according to the invention;

FIG. 5A is a cross-sectional view of an embodiment of an electronic apparatus according to the invention;

FIG. 5B is a plan view schematically illustrating an embodiment of a configuration of a digitizer according to the invention;

FIGS. 6A to 6C are plan views of an embodiment of an electronic apparatus according to the invention;

FIGS. 7A to 7D are plan views of an embodiment of an electronic apparatus according to the invention; and

FIGS. 8A to 8C are plan views of an embodiment of an electronic apparatus according to the invention.

### DETAILED DESCRIPTION

In the specification, it will be understood that when an element (or a region, a layer, a portion, or the like) is referred to as being “on”, “connected to” or “coupled to” another element, it can be directly disposed on, connected or coupled to another element mentioned above, or intervening elements may be disposed therebetween.

Like numbers refer to like elements throughout. Also, in the drawings, the thicknesses, ratios, and dimensions of the elements are exaggerated for effective description of the technical contents.

The term “and/or” includes one or more combinations which can be defined by the associated elements.

Although the terms first, second, etc. may be used herein to describe various elements, these elements should not be limited by these terms. These terms are only used to distinguish one element from another element. For example, a first element may be referred to as a second element, and similarly, a second element may be referred to as a first element without departing from the scope of the invention. The singular forms include the plural forms as well, unless the context clearly indicates otherwise.

Also, terms such as “below”, “lower”, “above”, and “upper” may be used to describe the relationships of the components illustrated in the drawings. These terms have a relative concept and are described on the basis of the directions indicated in the drawings.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. A term “module” or “unit” may mean a circuit or a processor, for example.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

Hereinafter, embodiments of the invention will be described with reference to the accompanying drawings.

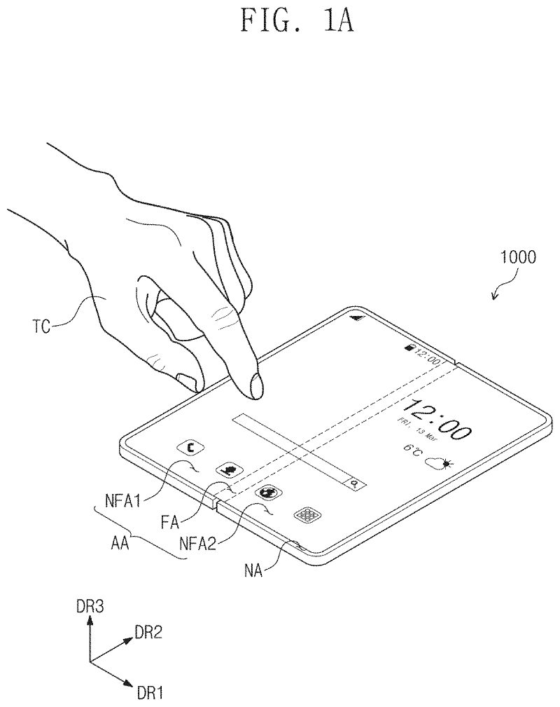

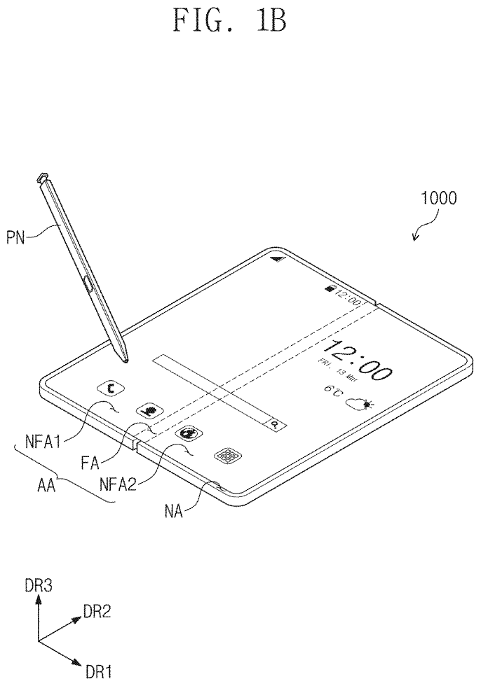

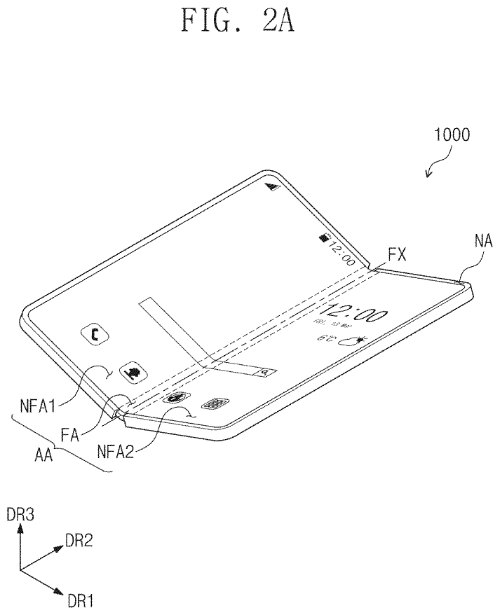

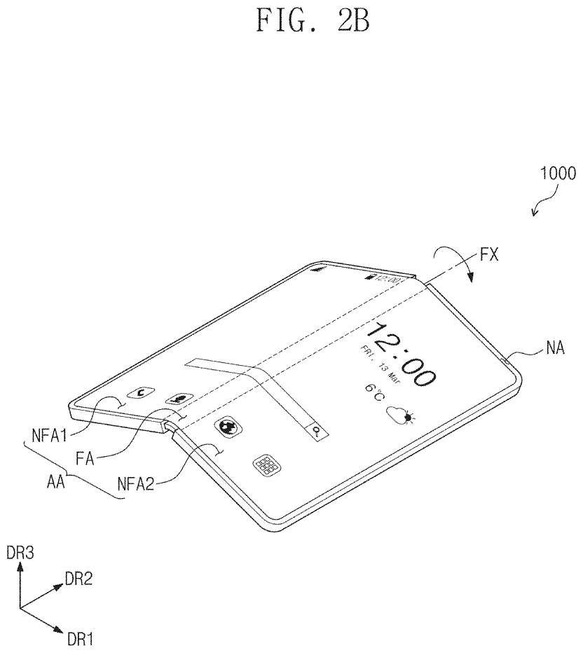

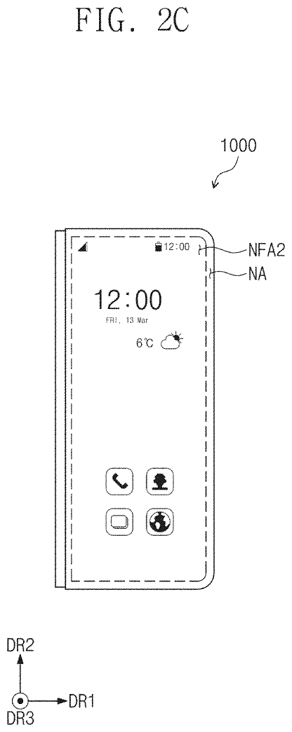

FIGS. 1A and 1B are perspective views of an embodiment of an electronic apparatus according to the invention. FIGS. 2A and 2B are perspective views of an embodiment of an electronic apparatus according to the invention. FIG. 2C is a plan view of an embodiment of an electronic apparatus according to the invention. FIGS. 1A and 1B illustrate an electronic apparatus 1000 in an unfolded state, and FIGS. 2A to 2C illustrate the electronic apparatus 1000 in a folded state. Hereinafter, an embodiment of the invention will be described with reference to FIGS. 1A to 2C.

Referring to FIGS. 1A and 1B, the electronic apparatus 1000 may be an apparatus activated in response to an electrical signal. In an embodiment, the electronic apparatus 1000 may be a mobile phone, a tablet personal computer (“PC”), a vehicle navigation unit, a game console, or a wearable apparatus, for example, but the invention is not limited thereto. In FIGS. 1A and 1B, the electronic apparatus 1000 is illustrated as a mobile phone.

The electronic apparatus 1000 may display an image and sense an external input. The electronic apparatus 1000 may display an image through an active area AA. In the electronic apparatus 1000 illustrated in FIGS. 1A and 1B, the active area AA may include a plane defined by a first direction DR1 and a second direction DR2.

A thickness direction of the electronic apparatus 1000 may be parallel to a third direction DR3 that crosses the first direction DR1 and the second direction DR2. Thus, a front surface (or a top surface) and a rear surface (or a bottom surface) of members constituting the electronic apparatus 1000 may be defined by the third direction DR3.

The electronic apparatus 1000 may sense an external input applied from the outside. The external input may be an input of a user. The input of the user may include various types of inputs such as a portion of the user's body, an electromagnetic instrument (e.g., electromagnetic pen PN), light, heat, or pressure.

The electronic apparatus 1000 may sense a plurality of external inputs. In an illustrated embodiment of FIG. 1A, a user's hand TC is illustrated as the external inputs, for example. The electronic apparatus 1000 may sense the input position or intensity of the user's hand TC through capacitance or impedance changed by the user's hand TC.

Also, in an illustrated embodiment of FIG. 1B, an electromagnetic pen PN is illustrated as the external inputs, for example. However, the invention is not limited thereto, and the external inputs may include various other instruments. The electronic apparatus 1000 may sense the input position or intensity of the electromagnetic pen PN through electro magnetic resonance (“EMR”) due to an electromagnetic induction generated between magnetic field generated inside the electronic apparatus 1000 and the electromagnetic pen PN.

Referring to FIGS. 2A and 2C, the electronic apparatus 1000 may be folded. In the embodiment, the electronic apparatus 1000 may be folded about a folding axis FX extending in parallel to the second direction DR2.

The folding axis FX is illustrated as extending in the second direction DR2 in FIGS. 2A and 2B, but the invention is not limited thereto. In an embodiment, the folding axis FX may extend in a direction parallel to the first direction DR1, for example. In this case, a first area NFA1, a folding area FA, and a second area NFA2 may be arranged in this order in the second direction DR2.

The active area AA may include a first area NFA1, a folding area FA, and a second area NFA2, which are arranged in this order in the first direction DR1. The folding area FA may be an area that forms a flat or curved surface with respect to the folding axis FX according to folding operation of the electronic apparatus 1000. The first area NFA1 and the second area NFA2 may be an area of which a shape is maintained flat according to the folding operation of the electronic apparatus 1000. Only the positions of the first area NFA1 and the second area NFA2 are moved according to the folding operation of the electronic apparatus 1000, but shape deformation thereof does not occur.

As illustrated in FIG. 2A, when the electronic apparatus 1000 is folded, the folding area FA may form a curved surface concavely curved toward the folding axis FX, and the first area NFA1 and the second area NFA2 may face each other. Thus, the active area AA may not be exposed to the outside in a completely folded state, and this state may be referred to as in-folding.

In an alternative embodiment, as illustrated in FIGS. 2B and 2C, when the electronic apparatus 1000 is folded, the folding area FA may form a curved surface convexly curved toward the folding axis FX. Thus, the first area NFA1 and the second area NFA2 may display images in directions opposite to each other in a completely folded state, and this state may be referred to as out-folding. Accordingly, in the completely out-folded state as illustrated in FIG. 2C, the first area NFA1 may not be exposed from a location where the second area NFA2 is viewed.

In the embodiment, the electronic apparatus 1000 may be unfolded or folded about the folding axis FX and is illustrated as being in-folded or out-folded when folded. However, this is merely an example, and the operation of the electronic apparatus 1000 is not limited thereto. In an embodiment, the electronic apparatus 1000 may be folded such that only in-folding is possible or only out-folding is possible, for example. The electronic apparatus 1000 in an embodiment of the invention may be designed to various shapes as long as it is foldable about the folding axis FX, and is not limited to any particular embodiment.

Here, the embodiment having one folding area is illustrated in FIGS. 1A to 2C, but the number of folding areas is not limited thereto. In an embodiment, the electronic apparatus 1000 may include three or more areas and a plurality of folding areas each of which is disposed between the neighboring areas, for example.

Also, the electronic apparatus 1000 in the embodiment of the invention may provide sensing areas, which are different depending on types of external inputs. In an embodiment, an input of the user's hand TC may be sensed over the entire surface of the active area AA, for example. An input of the electromagnetic pen PN may be sensed on only a portion of the active area AA. An input of the electromagnetic pen PN may be sensed on regions except for the folding area FA in the active area AA, in particular, on the first area NFA1 and the second area NFA2. In an embodiment of the invention, the electronic apparatus 1000 is designed such that the folding area FA is excluded from the sensing areas for the electromagnetic pen PN, and thus it is possible to prevent sensing failures of the electromagnetic pen PN in the foldable electronic apparatus. This will be described in detail later.

Also, although not illustrated, the active area AA may overlap at least one electronic module. In an embodiment, the electronic modules may include a camera module, a proximity luminance sensor, or the like, for example. The electronic modules may receive an external input transmitted through the active area AA or provide an output through the active area AA. The portions of the active area AA overlapping the camera module, the proximity luminance sensor, or the like may have higher transmittance than the other portions of the active area AA. Thus, the areas where the plurality of electronic modules is to be disposed may not be provided in a peripheral area NA adjacent to the active area AA. As a result, the area ratio of the active area AA to the entire surface of the electronic apparatus 1000 may increase.

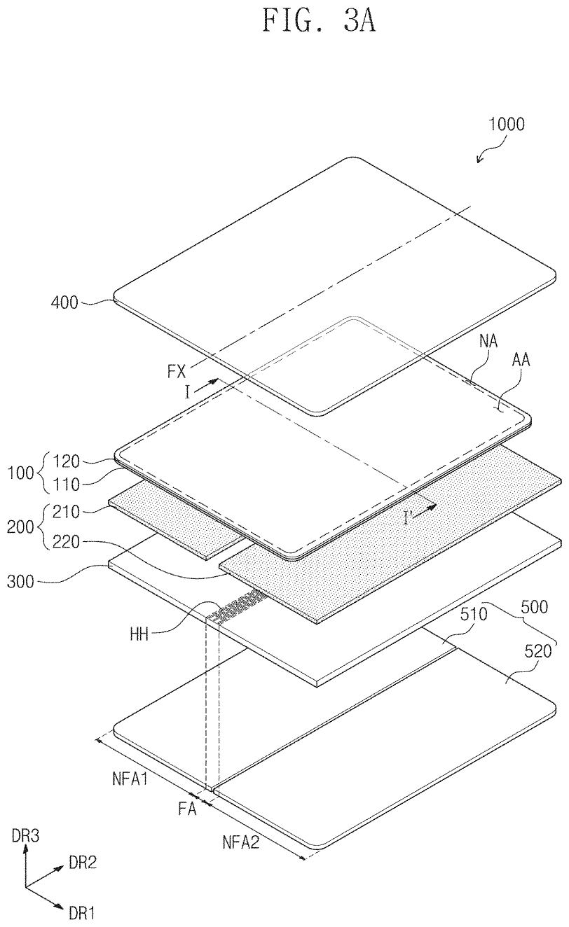

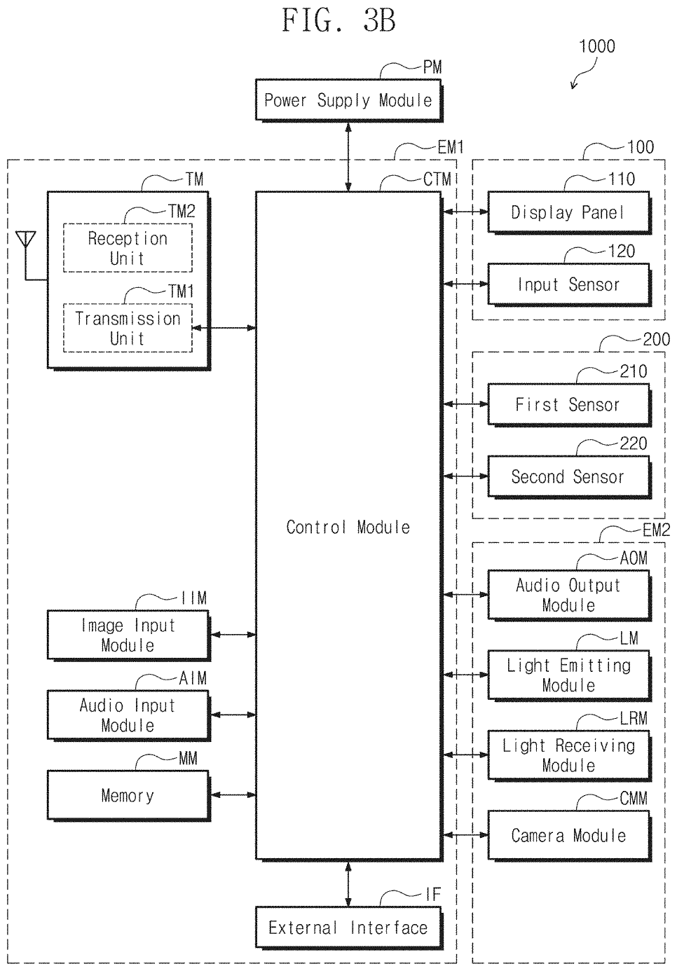

FIG. 3A is an exploded perspective view of an embodiment of an electronic apparatus according to the invention. FIG. 3B is a block diagram of the electronic apparatus illustrated in FIG. 3A. FIG. 3A schematically illustrates an exploded perspective view of the electronic apparatus 1000 of FIG. 1A, and even some components omitted in FIG. 3A are illustrated as blocks in FIG. 3B. Hereinafter, an embodiment of the invention will be described with reference to FIGS. 3A and 3B.

As illustrated in FIG. 3A, the electronic apparatus 1000 may include an electronic panel 100, a sensing module 200, a support plate 300, a window 400, and a lower protective member 500.

The electronic panel 100 may be flexible panel. Accordingly, the electronic panel 100 may be rolled entirely, or folded or unfolded about a folding axis FX (refer to FIGS. 2A and 2B). The electronic panel 100 may include a display panel 110 and an input sensor 120.

The display panel 110 generates an image. The display panel 110 may be a light emitting-type display panel, but is not particularly limited thereto. In an embodiment, the display panel 110 may be an organic light emitting display panel or a quantum-dot light emitting display panel, for example. A light emitting layer of the organic light emitting display panel may include an organic light emitting material. A light emitting layer of the quantum-dot light emitting display panel may include quantum dots, quantum rods, or the like. Hereinafter, the display panel 110 is described as the organic light emitting display panel.

The display panel 110 may include a plurality of pixels (not shown). Each of the pixels may include at least one transistor and a display element electrically connected to the transistor. Each of the display elements displays light to create an image. The active area AA may be a region in which the display elements are arranged.

The display element may be a light emitting element that includes a liquid crystal capacitor, an electrophoretic capacitor, or a light emitting element layer. The light emitting element may be an organic light emitting element including the organic layer or a quantum-dot light emitting element including the quantum dots. However, this is merely described as an example. The display panel 110 may include various types of pixels as long as they display an image, and is not limited to any particular embodiment.

The input sensor 120 is disposed on the display panel 110. The input sensor 120 may sense an external input. In the embodiment, the input sensor 120 may sense a signal transmitted from the user's hand TC (refer to FIG. 1A). The input sensor 120 may sense the positions and/or intensities of the user's hand TC applied over the entire surface of the active area AA. However, this is merely described as an example. The input sensor 120 may sense various types of inputs, and is not limited to any particular embodiment.

The input sensor 120 may be disposed directly on the display panel 110. In an embodiment of the invention, the input sensor 120 may be formed or disposed on the display panel 110 through a continuous process. That is, the input sensor 120 may be provided directly on the display panel 110 without a coupling member such as a separate adhesive film. However, the invention is not limited thereto, and the input sensor 120 may be coupled to the display panel 110 with a coupling member such as an adhesive film therebetween. In this case, the input sensor 120 is manufactured through a process independent of the display panel 110 and then may be coupled to the top surface of the display panel 110 through an adhesive film.

The sensing module 200 may be disposed between the electronic panel 100 and the support plate 300. The sensing module 200 may sense an external input different from an external input sensed by the electronic panel 100. In an embodiment, the sensing module 200 may sense a signal transmitted by the electromagnetic pen PN (refer to FIG. 1B), for example. That is, in the embodiment, the input sensor 120 disposed on the display panel 110 may sense the external input from the user's hand TC and the sensing module 200 disposed between the electronic panel 100 and the support plate 300 may sense the external input from the electromagnetic pen PN.

The sensing module 200 may include a first sensor 210 and a second sensor 220. Each of the first sensor 210 and the second sensor 220 may have the same structure and may be driven in the same manner. In the embodiment, each of the first sensor 210 and the second sensor 220 is illustrated as being driven in a manner using EMR through electromagnetic induction. However, this is merely described as an example. The first sensor 210 and the second sensor 220 may have structures different from each other or may be driven in different manners, but are not limited to any particular embodiment.

The first sensor 210 and the second sensor 220 may be disposed spaced apart from each other with a folding area FA therebetween. The first sensor 210 and the second sensor 220 may be spaced apart from each other in a direction crossing the folding axis FX, that is, in a first direction DR1.

The first sensor 210 may be disposed overlapping a first area NFA1, and the second sensor 220 may be disposed overlapping a second area NFA2. The first sensor 210 may sense the position or intensity of the electromagnetic pen PN applied to the first area NFA1. The second sensor 220 may sense the position or intensity of the electromagnetic pen PN applied to the second area NFA2.

In an embodiment of the invention, the electronic apparatus 1000 may sense external inputs which are input in various forms, and thus the utilization of the electronic apparatus 1000 may increase. Also, each of the first sensor 210 and the second sensor 220 includes a plurality of digitizers and may be disposed not overlapping the folding area FA.

The sensing module 200 is not disposed in the folding area FA in which shape deformation occurs due to the folding of the electronic apparatus 1000. That is, in the embodiment, the folding area FA may be an area displaying an image but not sensing the external input from the electromagnetic pen PN. Also, the folding area FA in the embodiment may be an area sensing the external input from the user's hand TC but not sensing the external input from the electromagnetic pen PN. That is, the folding area FA may be an area in which the pixels or the input sensor 120 do not overlap the sensing module 200 in a plan view.

In an embodiment of the invention, the sensing module 200 is not allowed to overlap the folding area FA, and thus it is possible to prevent damages to the sensing module 200 due to stress caused by the folding of the electronic apparatus 1000. Therefore, the reliability of the electronic apparatus 1000 may be improved. Also, the sensing module 200 does not need to secure flexibility, and thus a degree of freedom in designing the sensing module 200 may be improved.

The support plate 300 is disposed below the sensing module 200 to support the electronic panel 100 and the sensing module 200. The support plate 300 may have a plate shape. In an embodiment, as illustrated in FIG. 3A, the support plate 300 may be provided in the form of a single body plate having a shape corresponding to the shape of the electronic panel 100, for example. Here, this is merely illustrated as an example. The support plate 300 may be provided as divided into two or more parts respectively overlapping the first area NFA1 and the second area NFA2, but is not limited to any particular embodiment.

The support plate 300 may include a material having higher modulus than that of the electronic panel 100. In an embodiment, the support plate 300 may include metal, for example. In an embodiment, the support plate 300 may include stainless steel, aluminum, or an alloy thereof, for example. The support plate 300 includes metal and thus may serve as a heat dissipating layer as well as support the electronic panel 100. However, this is merely described as an example. The support plate 300 may include various materials as long as it may support the electronic panel 100, and is not limited to any particular embodiment.

A plurality of openings HH may be defined in the support plate 300 in an area overlapping the folding area FA. Each of the openings HH is defined as passing through the support plate 300. The openings HH may be arranged spaced apart from each other. The openings HH may be arranged, for example, in a zigzag form, but the invention is not limited thereto.

Also, the openings HH may be groove patterns recessed from the top surface or the bottom surface of the support plate 300. The thickness of the folding area FA of the support plate 300 is reduced by the openings HH, and thus the flexibility of the support plate 300 in the folding area FA may be improved.

The window 400 is disposed on the electronic panel 100 to protect the electronic panel 100. The external input is substantially provided on the window 400. The window 400 may include an optically transparent insulating material. Accordingly, an image generated in the electronic panel 100 may be easily recognized by a user after passing through the window 400.

For example, the window 400 may include thin film glass or a synthetic resin film. In an embodiment, when the window 400 includes the thin film glass, the thickness of the window 400 may be about 100 micrometers (μm) or less and, for example, about 30 μm, but the thickness of the window 400 is not limited thereto. In an embodiment, when the window 400 includes the synthetic resin film, the window 400 may include a polyimide (“PI”) film or a polyethylene terephthalate (“PET”) film.

The window 400 may have a multilayer structure or a single layer structure. In an embodiment, the window 400 may include a plurality of synthetic resin films coupled by an adhesive, or a glass substrate and a synthetic resin film which are coupled to each other by an adhesive, for example. The window 400 may include a flexible material. Accordingly, the window 400 may be folded or unfolded about the folding axis FX. That is, when the shape of the electronic panel 100 is deformed, the shape of the window 400 may also be deformed according to the shape of the electronic panel 100.

The window 400 relieves external impact as well as allows an image from the electronic panel 100 to pass therethrough, thus preventing the electronic panel 100 from being damaged or malfunctioning due to the external impact. The external impact is a force from the outside expressible as pressure, stress, or the like, and refers to a force that causes defects to the electronic panel 100.

Here, although not illustrated, the electronic apparatus 1000 may further include a protective layer disposed on the window 400. The protective layer may be a layer for improving impact resistance of the window 400 and preventing scattering when the window 400 is broken. The protective layer may include at least one selected from among a urethane-based resin, an epoxy-based resin, a polyester-based resin, a polyether-based resin, an acrylate-based resin, an acrylonitrile-butadiene-styrene (“ABS”) resin, and rubber. In an embodiment of the invention, the protective layer may include at least one of phenylene, PET, PI, polyamide (“PAI”), polyethylene naphthalate (“PEN”), or polycarbonate.

Also, although not illustrated, the electronic apparatus 1000 may further include one or more functional layers disposed between the electronic panel 100 and the window 400. In an embodiment, the functional layer may be an anti-reflection layer for preventing reflection of external light, for example. The anti-reflection layer may prevent elements constituting the electronic panel 100 from being visible from the outside due to the external light which is incident through the front surface of the electronic apparatus 1000. The anti-reflection layer may include a retarder, a polarizer, or a color filter.

The lower protective member 500 is disposed below the support plate 300. The lower protective member 500 may protect the electronic panel 100, the sensing module 200, and the support plate 300. In the embodiment, the lower protective member 500 may define an exterior of the electronic apparatus 1000 in conjunction with the window 400.

The lower protective member 500 may include a first protective member 510 and a second protective member 520. The first protective member 510 is disposed overlapping the first area NFA1, and the second protective member 520 is disposed overlapping the second area NFA2.

Here, although not illustrated, the lower protective member 500 may further include a connection module for connecting the first protective member 510 to the second protective member 520. The connection module may include a hinge module or a multi joint module. The lower protective member 500 further includes the connection module and thus may more stably protect portions of the electronic panel 100 or the support plate 300 which overlap the folding area FA.

Referring to FIG. 3B, an electronic apparatus 1000 may include an electronic panel 100, a sensing module 200, a power supply module PM, a first electronic module EM1, and a second electronic module EM2. In FIG. 3B, electrical connection relationships between components constituting the electronic apparatus 1000 are illustrated as blocks. As illustrated in FIG. 3B, the electronic panel 100, the sensing module 200, the power supply module PM, the first electronic module EM1, and the second electronic module EM2 may be electrically connected to each other.

The first electronic module EM1 and the second electronic module EM2 may include various functional modules for operating the electronic apparatus 1000. The first electronic module EM1 may be directly disposed (e.g., mounted) on a motherboard electrically connected to the electronic panel 100, or may be disposed (e.g., mounted) on a separate substrate and electrically connected to a motherboard through a connector (not shown) or the like.

The first electronic module EM1 may include a control module CTM, a wireless communication module TM, an image input module IIM, an audio input module AIM, a memory MM, and an external interface IF. Some of the modules may not be disposed (e.g., mounted) on a motherboard, but may be electrically connected to the motherboard through a flexible circuit board.

The control module CTM controls overall operation of the electronic apparatus 1000. The control module CTM may be a microprocessor. In the embodiment, each of the electronic panel 100, the sensing module 200, and the second electronic module EM2 may be electrically connected to the control module CTM.

For example, the control module CTM activates or deactivates the electronic panel 100. The control module CTM may control other modules such as the image input module IIM or the audio input module AIM on the basis of a touch signal received from the electronic panel 100.

The wireless communication module TM may transmit and receive a wireless signal to and from another terminal by Bluetooth or Wi-Fi line. The wireless communication module TM may transmit and receive an audio signal by a general communication line. The wireless communication module TM includes a transmission unit TM1 which modulates a signal to be transmitted and transmits the signal and a reception unit TM2 which demodulates a received signal.

The image input module IIM processes an image signal and coverts the image signal into image data which may be displayed through the electronic panel 100. The audio input module AIM receives an external audio signal through a microphone in a recording mode, a voice recognition mode, or the like, and converts the received audio signal into electrical voice data.

The external interface IF serves as an interface connected to an external charger, wired/wireless data ports, a card socket (e.g., a memory card, a subscriber identity module (“SIM”)/user identity module (“UIM”) card), or the like.

The second electronic module EM2 may include an audio output module AOM, a light emitting module LM, a light receiving module LRM, a camera module CMM, or the like. The components mentioned above may be directly disposed (e.g., mounted) on a motherboard, disposed (e.g., mounted) on a separate substrate and electrically connected to the electronic panel 100 through a connector (not shown) or the like, or electrically connected to the first electronic module EM1.

The audio output module AOM converts audio data received from the wireless communication module TM or audio data stored in the memory MM and then outputs the converted audio data to the outside.

The light emitting module LM generates and outputs light. The light emitting module LM may output infrared light. In an embodiment, the light emitting module LM may include a light emitting diode (“LED”) element, for example. In an embodiment, the light receiving module LRM may sense infrared light, for example. The light receiving module LRM may be activated when the infrared light having a predetermined level or higher is sensed. The light receiving module LRM may include a complementary metal oxide semiconductor (“CMOS”) sensor. The infrared light generated in the light emitting module LM is output and then reflected by an external object (e.g., the finger or face of a user). The reflected infrared light may be incident onto the light receiving module LRM. The camera module CMM captures an external image.

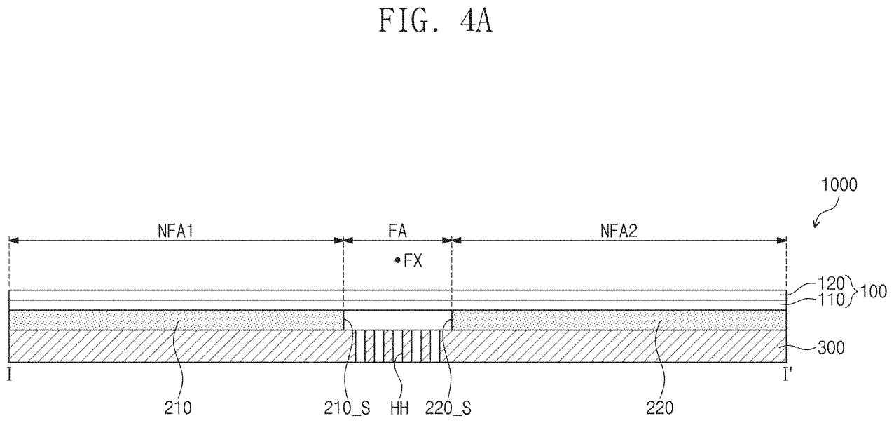

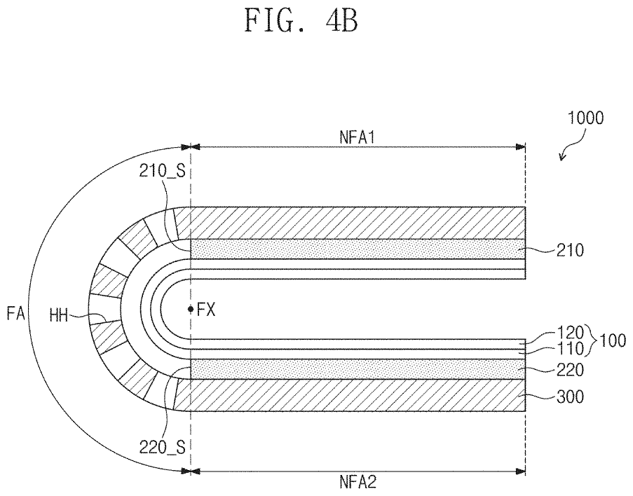

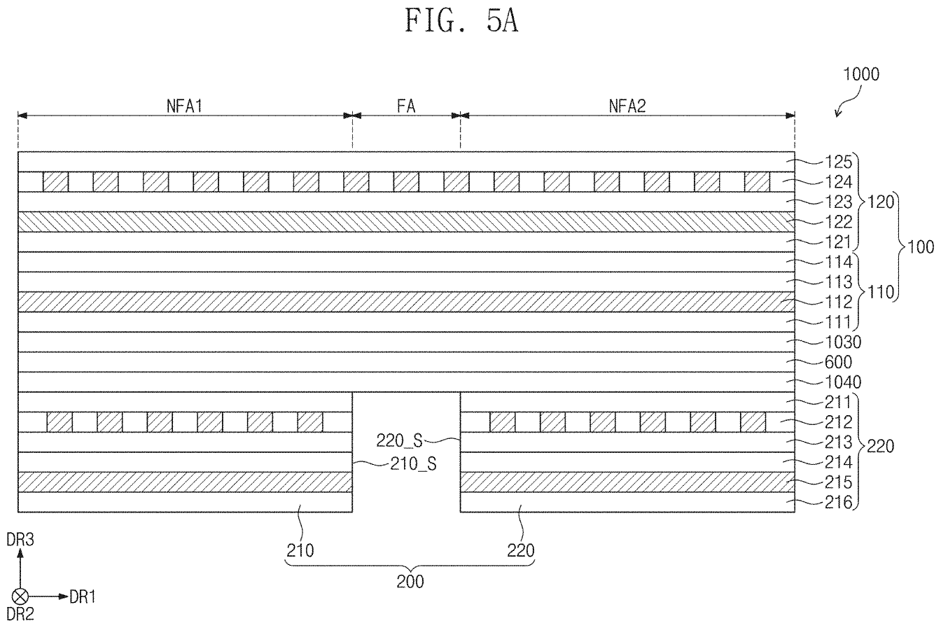

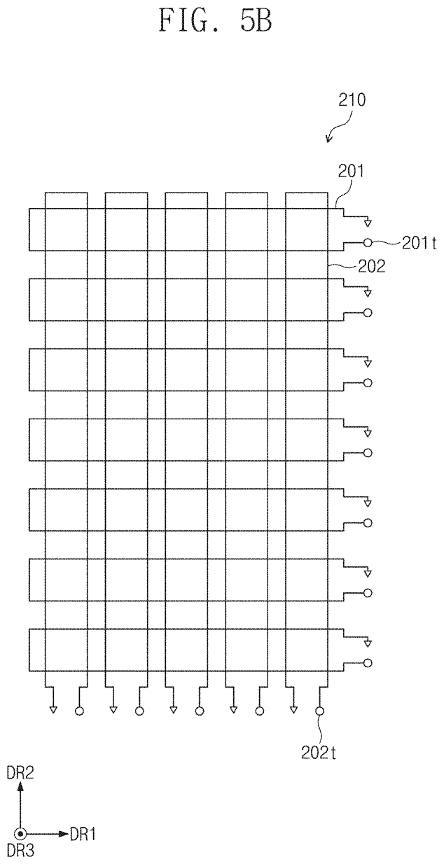

FIGS. 4A and 4B are cross-sectional views of an embodiment of an electronic apparatus according to the invention. FIG. 5A is a cross-sectional view of an embodiment of an electronic apparatus according to the invention. FIG. 5B is a plan view schematically illustrating an embodiment of a configuration of a digitizer according to the invention.

FIG. 4A illustrates an unfolded state of an electronic apparatus and illustrates a cross-sectional view taken along line I-I′ of FIG. 3A. FIG. 4B illustrates an in-folding state of an electronic apparatus and illustrates a state corresponding to that of FIG. 2A. Here, FIGS. 4A and 4B illustrate an electronic panel 100, first and second sensors 210 and 220, and a support plate 300 among components of an electronic apparatus 1000 for ease of description, and FIG. 5A illustrates a stacking relationship between the components of the electronic apparatus 1000. Hereinafter, an embodiment of the invention will be described with reference to FIGS. 4A to 5B.

As illustrated in FIGS. 4A and 4B, the electronic apparatus 1000 may be unfolded or folded about a folding axis FX. When the electronic apparatus 1000 is in-folded, the electronic panel 100 is disposed to face each other, and a first area NFA1 and a second area NFA2 overlap each other. As the support plate 300 is folded about the folding axis FX, the areas of openings HH of the support plate 300 may increase.

The first sensor 210 and the second sensor 220 may be disposed spaced apart from each other with a folding area FA therebetween. Side surfaces 210_S and 220_S which face each other in the first sensor 210 and the second sensor 220 define an empty space corresponding to the folding area FA and are spaced apart from each other.

Hereinafter, a layer structure in an embodiment of the invention will be described in detail with reference to FIGS. 5A and 5B.

As illustrated in FIG. 5A, a display panel 110 may include a base layer 111, a circuit layer 112, a light emitting element layer 113, and an encapsulation layer 114.

The base layer 111 may include a synthetic resin layer. The synthetic resin layer may include thermosetting resin. The base layer 111 may have a multilayer structure. In an embodiment, the base layer 111 may have a three layer structure of a synthetic resin layer, an adhesive layer, and a synthetic resin layer, for example. In particular, the synthetic resin layer may be a polyimide-based resin layer, but the material thereof is not particularly limited. In an embodiment, the synthetic resin layer may include at least one of an acryl-based resin, a methacryl-based resin, polyisoprene, a vinyl-based resin, an epoxy-based resin, a urethane-based resin, a cellulose-based resin, a siloxane-based resin, a polyamide-based resin, or a perylene-based resin. In addition, the base layer 111 may include a glass substrate or an organic/inorganic composite material substrate, or the like.

The circuit layer 112 may be disposed on the base layer 111. The circuit layer 112 may include an insulating layer, a semiconductor pattern, a conductive pattern, a signal line, or the like. The insulating layer, the semiconductor layer, and the conductive layer are formed or disposed on the base layer 111 through processes such as coating and deposition, and subsequently, the insulating layer, the semiconductor layer, and the conductive layer may be selectively patterned through photolithography processes performed multiple times. Subsequently, the semiconductor pattern, the conductive pattern, and the signal line included in the circuit layer 112 may be formed or provided.

The light emitting element layer 113 may be disposed on the circuit layer 112. The light emitting element layer 113 may include a light emitting element. In an embodiment, the light emitting element layer 113 may include an organic light emitting material, a quantum dot, a quantum rod, or micro LED, for example.

The encapsulation layer 114 may be disposed on the light emitting element layer 113. The encapsulation layer 114 may include an inorganic layer, an organic layer, and an inorganic layer which are stacked in this order, but layers constituting the encapsulation layer 114 are not limited thereto.

The inorganic layers may protect the light emitting element layer 113 from moisture and oxygen, and the organic layer may protect the light emitting element layer 113 from foreign substances such as dust particles. In an embodiment, the inorganic layers may include a silicon nitride layer, a silicon oxynitride layer, a silicon oxide layer, a titanium oxide layer, an aluminum oxide layer, or the like. The organic layer may include an acrylic-based organic layer, but the invention is not limited thereto.

In the embodiment, the input sensor 120 is disposed directly on the display panel 110. The input sensor 120 may include a base insulating layer 121, a first conductive layer 122, a sensing insulating layer 123, a second conductive layer 124, and a cover insulating layer 125.

The base insulating layer 121 may be disposed directly on the display panel 110. In an embodiment, the base insulating layer 121 may be in direct contact with the encapsulation layer 114, for example. The base insulating layer 121 may have a single layer or multilayer structure. In another embodiment, the base insulating layer 121 may be omitted. Also, the base insulating layer 121 may be provided on a separate base layer, and the base layer may be coupled to the display panel 110 through an adhesive member.

Each of the first conductive layer 122 and the second conductive layer 124 may have a single layer structure or a multilayer structure in which layers are stacked in the third direction DR3. The conductive layer having the single layer structure may include a metal layer or a transparent conductive layer. In an embodiment, the metal layer may include molybdenum, silver, titanium, copper, aluminum, and an alloy thereof. In an embodiment, the transparent conductive layer may include transparent conductive oxides such as an indium tin oxide (“ITO”), an indium zinc oxide (“IZO”), a zinc oxide (“ZnO”), and an indium zinc tin oxide (“IZTO”). In an embodiment, the transparent conductive layer may include a conductive polymer such as poly(3,4-ethylenedioxythiophene) (“PEDOT”), metal nanowire, graphene, or the like.

The conductive layer having the multilayer structure may include multiple metal layers. In an embodiment, the multiple metal layers may have, for example, a three layer structure of titanium/aluminum/titanium. The conductive layer having the multilayer structure may include at least one metal layer and at least one transparent conductive layer.

Each of the first conductive layer 122 and the second conductive layer 124 may include patterns that constitute sensing electrodes. The input sensor 120 may acquire information about an external input through a change in capacitance between the sensing electrodes.

The sensing insulating layer 123 is disposed between the first conductive layer 122 and the second conductive layer 124 and may cover the first conductive layer 122. A portion of the second conductive layer 124 may be electrically connected to a portion of the first conductive layer 122 through a contact hole that passes through the sensing insulating layer 123. The cover insulating layer 125 is disposed on the sensing insulating layer 123 and may cover the second conductive layer 124.

At least one of the base insulating layer 121, the sensing insulating layer 123, or the cover insulating layer 125 may include an inorganic film. In an embodiment, the inorganic film may include at least one of aluminum oxide, titanium oxide, silicon oxide, silicon oxynitride, zirconium oxide, or hafnium oxide.

At least one of the base insulating layer 121, the sensing insulating layer 123, or the cover insulating layer 125 may include an organic film. In an embodiment, the organic film may include at least one of an acryl-based resin, a methacryl-based resin, polyisoprene, a vinyl-based resin, an epoxy-based resin, a urethane-based resin, a cellulose-based resin, a siloxane-based resin, a polyimide-based resin, a polyamide-based resin, or a perylene-based resin.

Here, an electronic apparatus 1000 in the embodiment may further include a lower protective film 600 disposed between an electronic panel 100 and a sensing module 200. The lower protective film 600 may be coupled to the rear surface of the electronic panel 100 through an adhesive layer 1030. The lower protective film 600 may prevent scratches from occurring on the rear surface of the electronic panel 100 during the manufacturing process for the electronic panel 100. The lower protective film 600 may be a colored polyimide film. In an embodiment, the lower protective film 600 may be an opaque yellow film, for example, but the invention is not limited thereto.

The sensing module 200 may be coupled to the rear surface of the lower protective film 600 through an adhesive layer 1040. The sensing module 200 includes first and second sensors 210 and 220. Each of first and second sensors 210 and 220 may include a digitizer. Each of the first and second sensors 210 and 220 may sense an external input by EMR through electromagnetic induction.

In an EMR method, a magnetic field may be generated in a resonant circuit provided inside the electromagnetic pen PN, signals may be induced, by the oscillating magnetic field, in a plurality of coils included in each of the first and second sensors 210 and 220, and the positions of the electromagnetic pen PN may be detected through the signals induced to the coils. In the embodiment, each of the first and second sensors 210 and 220 is illustrated as having the same structure. Hereinafter, a layer structure of the second sensor 220 will be described.

The second sensor 220 may include a first base film 211, a first conductive layer 212, an insulating layer 213, a second base film 214, a second conductive layer 215, and a third base film 216. The first base film 211, the first conductive layer 212, the insulating layer 213, the second base film 214, the second conductive layer 215, and the third base film 216 may be stacked in this order in a direction away from the electronic panel 100.

The first base film 211 may be coupled to the lower protective film 600 through the adhesive layer 1040. In an embodiment, the first base film 211 may include a plastic film and may include, for example, at least one of polyethyleneterephthalate (“PET”), polyimide (“PI”), polyamide (“PAI”), polyethylene naphthalate (“PEN”), or polycarbonate.

The first conductive layer 212 may be disposed on the bottom surface of the first base film 211. The first conductive layer 212 includes a conductive material. In an embodiment, the first conductive layer 212 may include copper, for example, but the invention is not limited thereto.

The first conductive layer 212 may include a plurality of conductive patterns. The conductive patterns may constitute coils for the electromagnetic resonance. In an embodiment, some conductive patterns may constitute first coils 201 of FIG. 5B, and the other conductive patterns may constitute second coils 202 of FIG. 5B, for example. Also, all of the conductive patterns may be included in the first coils 201, or all of the conductive patterns may be included in the second coils 202.

The insulating layer 213 is disposed between the first base film 211 and the second base film 214. The insulating layer 213 may include epoxy, but the invention is not limited thereto. The insulating layer 213 may cover the first conductive layer 212 to electrically insulate the first conductive layer 212 from the outside.

The second base film 214 is a base layer, which is disposed between the first base film 211 and the third base film 216 and on which the second conductive layer 215 is provided. The second base film 214 may be an insulating film.

The second conductive layer 215 may be disposed on the bottom surface of the second base film 214. The second conductive layer 215 may include a plurality of conductive patterns. In an embodiment, some conductive patterns may constitute first coils 201, and the other conductive patterns may constitute second coils 202, for example. Also, all of the conductive patterns may be included in the first coils 201, or all of the conductive patterns may be included in the second coils 202.

The third base film 216 covers a lower side of the second conductive layer 215 to protect the second conductive layer 215. Here, although not illustrated, an insulating layer for covering the second conductive layer 215 may be further provided between the third base film 216 and the second conductive layer 215.

FIG. 5B illustrates an embodiment of a first sensor 210 included in the sensing module 200. Referring to FIG. 5B, the first sensor 210 may include a plurality of first coils 201 and a plurality of second coils 202. The first coils 201 may be also referred to as driving coils, and the second coils 202 may be also referred to as sensing coils.

The first coils 201 may be arranged spaced apart from each other in a second direction DR2, and each may extend in a first direction DR1. The second coils 202 may be arranged spaced apart from each other in the first direction DR1, and each may extend in the second direction DR2.

In order to sense the electromagnetic pen PN (refer to FIG. 1B), alternate current signals are sequentially provided to first terminals 201t of the first coils 201. The first coils 201 are formed or provided in a closed curve shape. When electric current flows through the first coils 201, magnetic force lines may be induced between the first coils 201 and the second coils 202. The second coils 202 may output signals, which sense the induction electromagnetic force discharged from the electromagnetic pen PN, to second terminals 202t of the second coils 202.

FIG. 5B illustrates an embodiment of a configuration of a digitizer, but the invention is not limited thereto. Also, the arrangement relationship between the first coils 201 and the second coils 202 is not limited to that illustrated in FIG. 5B and may be modified diversely.

Referring back to FIG. 5A, the first sensor 210 and the second sensor 220 may be disposed spaced apart from each other with a folding area FA therebetween. One side surface 210_S of the first sensor 210 and one side surface 220_S of the second sensor 220 may face each other with the folding area FA therebetween in a first direction DR1.

In an embodiment of the invention, the electronic apparatus 1000 is provided with the first and second sensors 210 and 220 spaced apart from each other and thus may be designed such that the sensing module 200 does not overlap the folding area FA. Accordingly, it is possible to prevent the first conductive layer 212 or the second conductive layer 215 having the coils for sensing the electromagnetic pen PN from being damaged due to the folding. Therefore, it is possible to prevent damages due to folding stress such as cracks of the sensing module 200 and improve the reliability of the electronic apparatus 1000.

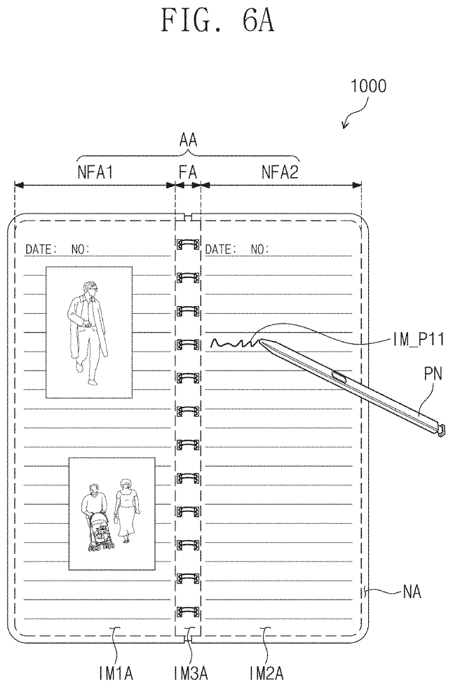

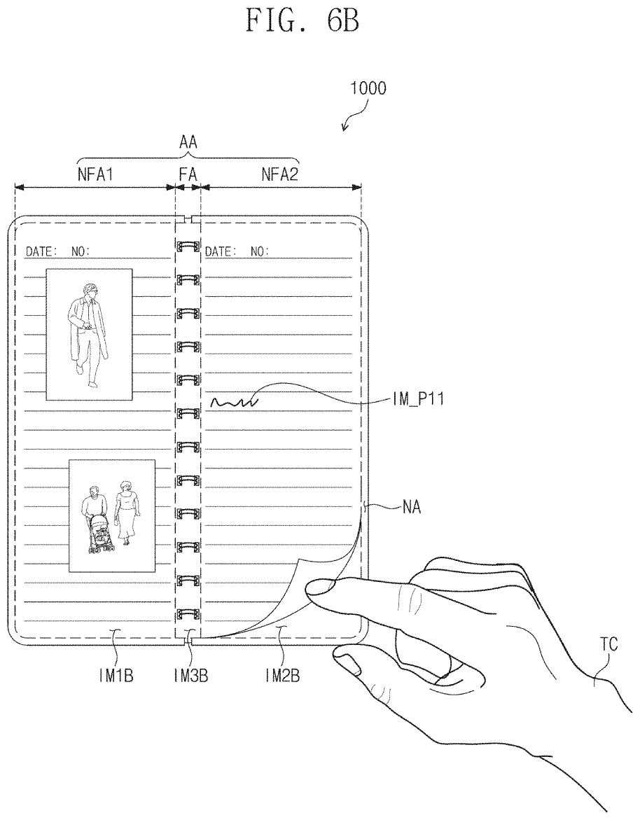

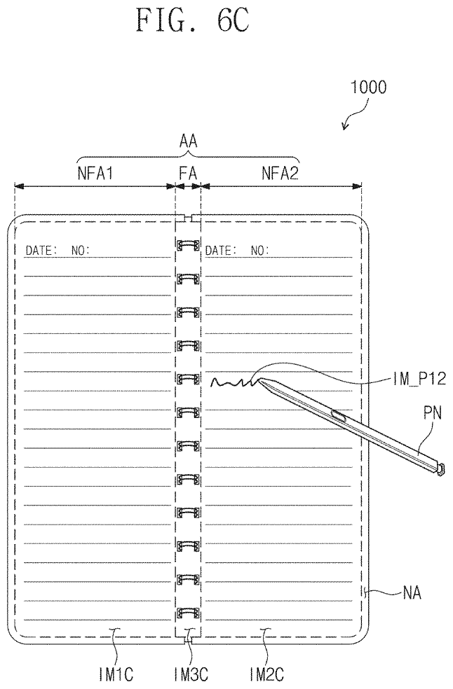

FIGS. 6A to 6C are plan views of an embodiment of an electronic apparatus according to the invention. FIGS. 6A to 6C illustrate utilization of an embodiment of an electronic apparatus 1000 according to various external inputs.

As illustrated in FIG. 6A, when the input of the electromagnetic pen PN is provided to the electronic apparatus 1000, the input of the electromagnetic pen PN is sensed through a first area NFA1 or a second area NFA2, but is not sensed in a folding area FA. Thus, the electronic apparatus 1000 in an embodiment of the invention may provide the folding area FA with an image that does not require an input of the electromagnetic pen PN.

In particular, the electronic apparatus 1000 displays images such that an image IM3A displayed on the folding area FA is different from an image IM1A displayed on the first area NFA1 or an image IM2A displayed on the second area NFA2. The image IM1A displayed on the first area NFA1 or the image IM2A displayed on the second area NFA2 may be an image such as a note that requires an input of the electromagnetic pen PN, but the image IM3A displayed on the folding area FA may be a spring image that connects notes.

Accordingly, as illustrated in FIG. 6A, a user provides the input of the electromagnetic pen PN to the second area NFA2 that requires the input of the electromagnetic pen PN such that a pen image IM_P11 is displayed on the second area NFA2. Subsequently, as illustrated in FIG. 6B, an image IM2B displayed on the second area NFA2 by an operation of a user's touch TC is displayed as an image in which a page is being turned over. An image IM3B displayed on the folding area FA may be still maintained as the spring image.

Subsequently, as illustrated in FIG. 6C, a note image on the next page may be provided in an active area AA. The image IM1C displayed on the first area NFA1 or the image IM2C displayed on the second area NFA2 may be an image of a note that requires an input of the electromagnetic pen PN, but the image IM3C displayed on the folding area FA may be still maintained as the spring image.

Accordingly, the input of the electromagnetic pen PN may be naturally guided and provided to the first area NFA1 or the second area NFA2, not the folding area FA. The user provides, through the electromagnetic pen PN, an input of the electromagnetic pen PN to the second area NFA2 which senses the input of the electromagnetic pen PN, and the electronic apparatus 1000 may output a pen image IM_P12 corresponding to the input.

The electronic apparatus 1000 in an embodiment of the invention may display, on the folding area FA, an image that does not require an input of the electromagnetic pen PN, and thus a sensing area for sensing the electromagnetic pen PN may not be provided in the folding area FA. Accordingly, although the electronic apparatus 1000 includes the sensing module 200 (refer to FIG. 3A) which does not overlap the folding area FA, a natural user environment may be provided.

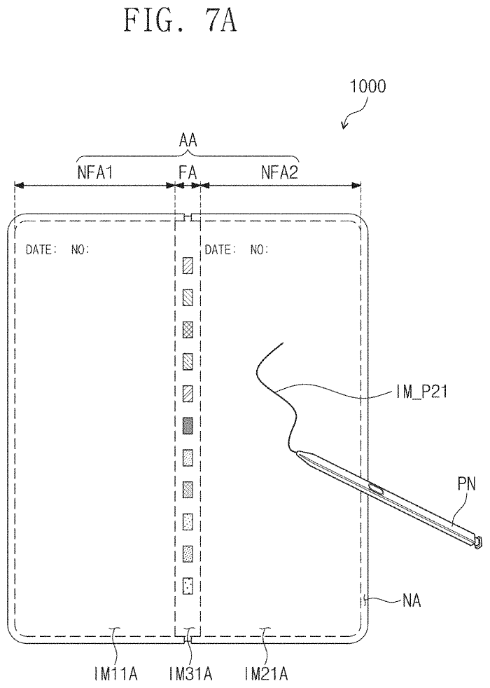

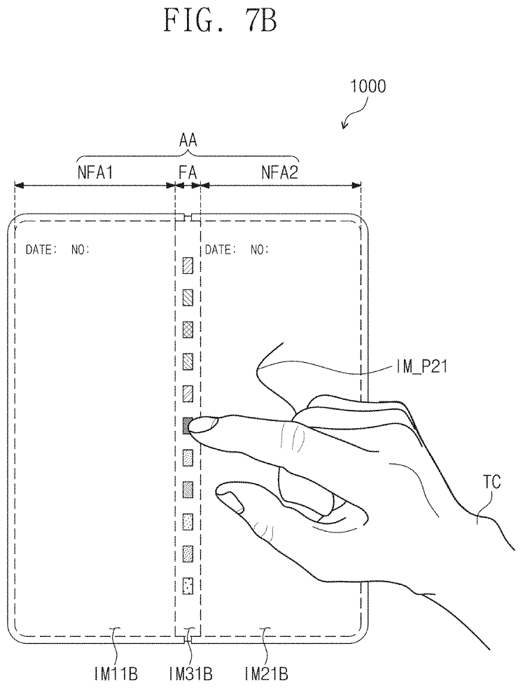

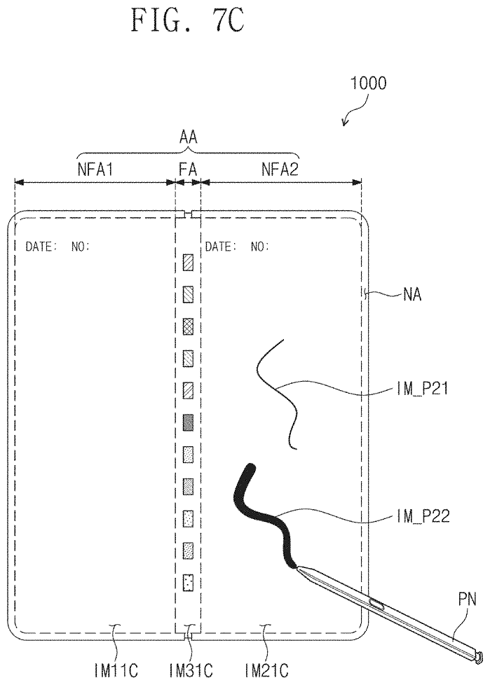

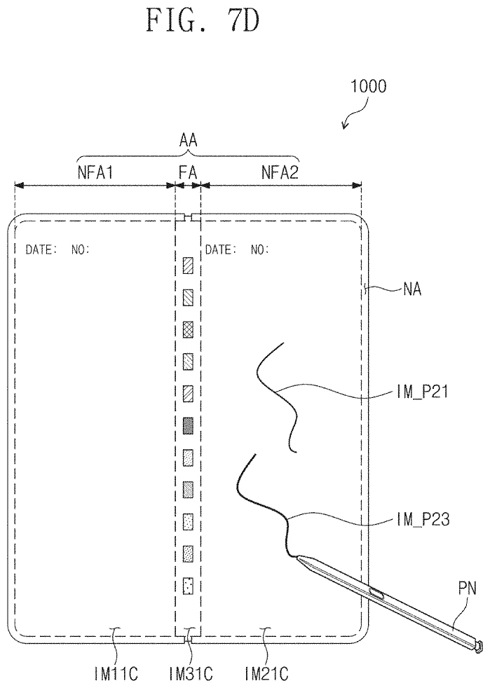

FIGS. 7A to 7D are plan views of an embodiment of an electronic apparatus according to the invention. FIGS. 7A to 7D illustrate utilization of an electronic apparatus 1000 according to various external inputs. Here, the same reference numerals may be given to the same components as those illustrated in FIGS. 6A to 6C, and their duplicated descriptions will be omitted.

As illustrated in FIG. 7A, an image IM31A displayed on a folding area FA may be an image for selecting a pen. An image IM11A displayed on a first area NFA1 or an image IM21A displayed on a second area NFA2 may be an image such as plain note. A user provides an input of the electromagnetic pen PN to the second area NFA2 on which the note image determined as enabling the input of the electromagnetic pen PN is displayed, and an electronic apparatus 1000 outputs a pen image IM_P21 corresponding to the input.

Subsequently, as illustrated in FIG. 7B, an image IM31B displayed on the second area FA between an image IM11B and an image IM21B is touched by a user's hand TC, and a pen feature may be selected. A sensing area for sensing the user's hand TC is provided over the entire surface of an active area AA in the electronic apparatus 1000. Thus, the folding area FA may sense information which is input through the user's hand TC instated of the electromagnetic pen PN.

Subsequently, as illustrated in FIG. 7C, the input of the electromagnetic pen PN is provided to the second area NFA2, and a new pen image IM_P22 may be provided in an image IM21C. The new pen image IM_P22 is output thicker than the previous pen image IM_P21. That is, when the pen is selected, thickness setting of a pen point might be changed. The previous images IM11B and IM31B may be maintained in images IM11C and IM31C, respectively.

Also, as illustrated in FIG. 7D, the input of the electromagnetic pen PN is provided to the second area NFA2, and a new pen image IM_P23 may be provided. The new pen image IM_P23 is output in a color different from that of the previous pen image IM_P21. That is, when the pen is selected, pen color setting might be changed.

In an embodiment of the invention, the electronic apparatus 1000 provides the folding area FA with the image that does not require the input of the electromagnetic pen PN and provides the first area NFA1 and the second area NFA2 with the images that require the input of the electromagnetic pen PN, and thus the input of the electromagnetic pen PN to the folding area FA may be naturally removed. Also, the image is provided in which the folding area FA may be utilized by the external input such as the user's hand TC different from the electromagnetic pen PN, and thus the utilization of the electronic apparatus 1000 capable of sensing various external inputs may be improved.

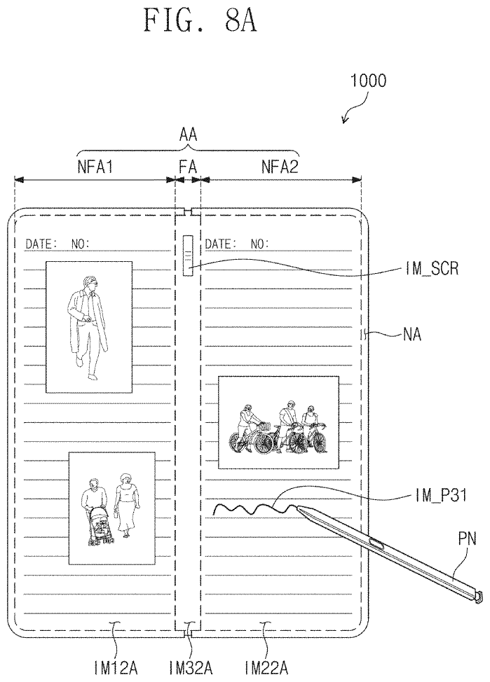

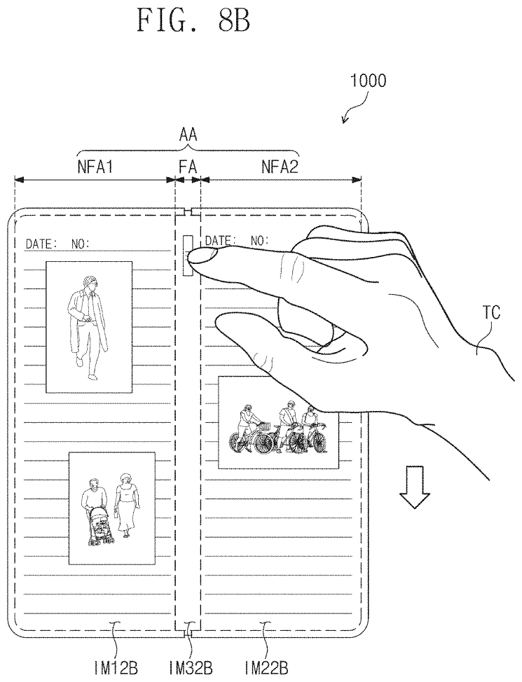

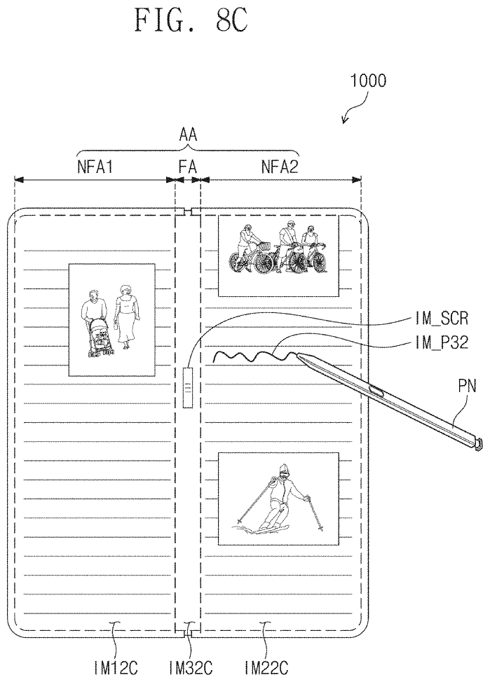

FIGS. 8A to 8C are plan views of an embodiment of an electronic apparatus according to the invention. FIGS. 8A to 8C illustrate utilization of an electronic apparatus 1000 according to various external inputs. Here, the same reference numerals may be given to the same components as those illustrated in FIGS. 6A to 6C, and their duplicated descriptions will be omitted.

As illustrated in FIGS. 8A to 8C, an image IM32A displayed on a folding area FA may be a scroll bar image IM_SCR. Images IM12A and IM22A displayed on a first area NFA1 and a second area NFA2, respectively, may be note images to which information is input by an electromagnetic pen PN. An input of the electromagnetic pen PN is provided in the second area NFA2, and a pen image IM_P31 corresponding to the input is displayed on the second area NFA2.

Subsequently, as illustrated in FIG. 8B, when a user's hand TC operates to move the scroll bar image IM_SCR downward, an image in which the scroll bar image IM_SCR is moving downward according to the operation may be displayed on the folding area FA.

Subsequently, as illustrated in FIG. 8C, images IM12C and IM22C corresponding to the movement of a scroll bar image IM_SCR shown in an image IM32C are displayed on the first area NFA1 and the second area NFA2, respectively, and the scroll bar image IM_SCR is displayed on the folding area FA. The input of the electromagnetic pen PN may be naturally guided to the first area NFA1 or the second area NFA2, and a pen image IM_P32 corresponding to the input of the electromagnetic pen PN may be displayed on the second area NFA2.

In an embodiment of the invention, the electronic apparatus 1000 provides the folding area FA with the image that does not require the input of the electromagnetic pen PN and provides the first area NFA1 and the second area NFA2 with the images that require the input of the electromagnetic pen PN, and thus the input of the electromagnetic pen PN to the folding area FA may be naturally removed. Also, the image is provided in which the folding area FA may be utilized by the external input such as the user's hand TC different from the electromagnetic pen PN, and thus the utilization of the electronic apparatus 1000 capable of sensing various external inputs may be improved.

According to the embodiment of the invention, it is possible to prevent damages to the sensing module due to folding stress. Also, in the embodiment of the invention, it is possible to improve utilization of the electronic apparatus because various types of external inputs may be sensed.

Although described with reference to an embodiment of the invention, it will be understood that various changes and modifications of the invention may be made by one ordinary skilled in the art or one having ordinary knowledge in the art without departing from the spirit and technical field of the invention as hereinafter claimed. Hence, the technical scope of the invention is not limited to the detailed description in the specification but should be determined only in accordance with the appended claims.

What is claimed is:

1. An electronic apparatus comprising:
an electronic panel which is foldable about a folding axis extending in a first direction and comprises an active area on which an image is displayed; and
a sensing module which is disposed below the electronic panel and senses an external input and comprises first and second sensors spaced apart from each other,
wherein the active area comprises a first area, a folding area, and a second area, which are arranged in a second direction crossing the first direction, and the folding axis overlaps the folding area in a plan view,
wherein the first sensor overlaps the first area, and the second sensor overlaps the second area and is spaced apart from the first sensor with the folding area therebetween in the plan view.

2. The electronic apparatus of claim 1, wherein at least one of the first sensor and the second sensor comprises a plurality of coils for electromagnetic induction.

3. The electronic apparatus of claim 1, wherein the electronic panel comprises a plurality of pixels which generate the image,
wherein some pixels of the plurality of pixels overlaps the folding area.

4. The electronic apparatus of claim 3, further comprising an input sensor which is disposed on the plurality of pixels and senses an external input having a different form from the external input sensed by the sensing module.

5. The electronic apparatus of claim 4, wherein the input sensor comprises a plurality of sensing patterns, and sensing patterns of the plurality of sensing patterns overlaps the folding area.

6. The electronic apparatus of claim 1, further comprising a support plate disposed below the sensing module,
wherein the support plate comprises metal.

7. The electronic apparatus of claim 6, wherein the support plate overlaps the folding area, the first area, and the second area.

8. The electronic apparatus of claim 7, wherein a plurality of holes, which overlap the folding area, are defined in the support plate.

9. An electronic apparatus comprising:
an electronic panel which is foldable about a folding axis extending in a first direction and senses a first external input; and
a sensing module which is disposed below the electronic panel and senses a second external input different from the first external input,
wherein the electronic panel comprises a folding area which is foldable about the folding axis and a first area and a second area which are spaced apart from each other with the folding area therebetween in a second direction crossing the first direction in a plan view, and the folding axis overlaps the folding area in the plan view,
wherein the sensing module does not overlap the folding area in the plan view.

10. The electronic apparatus of claim 9, wherein the second external input is an electromagnetic pen.

11. The electronic apparatus of claim 10, wherein the sensing module comprises a first sensor overlapping the first area and a second sensor overlapping the second area,
wherein the first sensor and the second sensor comprise side surfaces which face each other with the folding area therebetween.

12. The electronic apparatus of claim 9, wherein the electronic panel further comprises a display panel comprising a plurality of pixels,
wherein pixels of the plurality of pixels overlaps the folding area.

13. The electronic apparatus of claim 9, further comprising a support plate disposed below the sensing module,
wherein the support plate overlaps the folding area.

14. The electronic apparatus of claim 13, wherein a plurality of openings, which overlap the folding area, are defined in the support plate.

15. An electronic apparatus comprising:
an electronic panel which is foldable about a folding axis extending in a first direction and comprises an active area on which an image is displayed; and
a first sensor and a second sensor which are disposed below the electronic panel and spaced apart from each other, and each of which senses a first external input,
wherein the active area comprises a first area, a folding area, and a second area, which are arranged in a second direction crossing the first direction, and the folding axis overlaps the folding area in a plan view,
wherein the first sensor and the second sensor comprise side surfaces which face each other with the folding area therebetween.

16. The electronic apparatus of claim 15, wherein the first external input is not sensed in the folding area.

17. The electronic apparatus of claim 16, wherein the image comprises a first image provided in the first area, a second image provided in the second area, and a third image provided in the folding area,
wherein the first image and the second image are output corresponding to the first external input, and the third image does not correspond to the first external input.

18. The electronic apparatus of claim 15, wherein the electronic panel further comprises a sensing sensor which senses a second external input different from the first external input,
wherein the sensing sensor senses the second external input applied to the folding area.

19. The electronic apparatus of claim 18, wherein the third image is output corresponding to the second external input.

20. The electronic apparatus of claim 15, wherein each of the first sensor and the second sensor comprises a digitizer.
